(19) United States
(12) Patent Application Publication
(10) Pub. No.: US 2025/0043942 A1
(43) Pub. Date: Feb. 6, 2025

(54) Flexible Trim Device for Enhancing LED Strip Lights

(71) Applicant: Maxim Isaac, Windsor (CA)

(72) Inventor: Maxim Isaac, Windsor (CA)

(21) Appl. No.: 18/363,490

(22) Filed: Aug. 1, 2023

(51) Int. Cl. F21V 21/08

(52) U.S. Cl. CPC F21V 21/0808; F21V 7/0008; F21Y 2103/10; F21Y 2115/10

(57) ABSTRACT

The present invention is a trim device, an accessory item designed to enhance the lighting effects of LED strip lights. Molded into various cross-sectional shapes, the trim device comprises an elongated flexible elastic material such as rubber, silicone, or foam and features an open or a translucent/opaque additional side. Effectively housing and concealing LED strip lights inserted within, while allowing light to escape and reflect onto adjacent and opposing surfaces with positional installation, resulting in a visually pleasing and evenly dispersed ambient glow. Suitable for various indoor and outdoor lighting installations, the trim device is easily customizable, simple to install, and capable of housing LED strip lights of various sizes and configurations. By allowing light to project away from the line of sight eliminating the direct glare and accentuating the glow, it adds elegance and functionality to LIED strip light installations while maintaining a visually appealing ambiance with the lights on or off.

### CROSS-REFERENCE TO RELATED APPLICATIONS

This application claims priority from the U.S. provisional patent application Ser. No. 63/359,870, filed on Jul. 10, 2022, which is incorporated herein by reference in its entirety.

### FIELD OF THE INVENTION

The present invention relates to the field of lighting accessories specifically addressing the need for a versatile solution to enhance the functionality and aesthetics of LED strip lights. It introduces an all-in-one unit longitudinal flexible trim or moulding device meticulously designed to house, conceal, eliminate glare, and enhance the glow effects of LED strip lights, rope lights, or tape lights. This specialized trim is engineered to project the emitted light source of the inserted LED strip away from the line of sight, directing it onto adjacent and nearby opposing surfaces. The result is a visually pleasing and evenly dispersed ambient glow, effectively diffusing the direct glare emitted by the LED individual dots and lines. The invention offers a practical and aesthetically pleasing solution for concealing LED strip lights, enhancing their illumination, and improving the overall ambiance of various indoor and outdoor settings, including residential, commercial, and hospitality environments.

### BACKGROUND

In recent years, LED strip lights have gained popularity for their versatility in various lighting applications, including accentuating architectural features and enhancing decorative lighting arrangements. Despite their advantages in flexibility and energy efficiency, traditional LED strip lighting systems often face challenges due to exposed fixtures and direct glare emitted by individual LED dots and lines. Current solutions for concealing and diffusing glare typically involve complex assembly or installation of multi-part systems or rigid trim pieces, which may lack ease of installation, aesthetic appeal, or the ability to produce the desired ambient glow effect. DIY solutions using wood, plastic, or plaster trim require labor-intensive customization and specialized tools for proper fitting, lacking the simplicity and flexibility offered by the present invention.

Moreover, traditional LED strip diffusers primarily soften light dots into lines but fail to effectively diffuse glare away from the line of sight. While some LED strip models come fully encased in rubber or silicone material for glare diffusion, these are typically complete lighting assemblies rather than accessories designed specifically for enhancing LED strip lights.

Additionally, incorporating LED strips into architectural features such as bulkheads, covings, valances, and insets, ideal for achieving the desired ambient glow, poses challenges for most users due to the lack of built-in infrastructure in typical spaces and rooms. To address these limitations, there is a growing demand for a practical and aesthetically pleasing solution that effectively conceals LED strip lights, enhances their glow, and diffuses glare without the need for complex architectural modifications. Such a solution should be easy to install, adaptable to various environments, and seamlessly integrate into existing spaces.

The present invention addresses this need by introducing a novel trim or moulding device specifically designed to house, conceal, and enhance the appearance of LED strip lights. This versatile device can be installed on various surfaces, including walls, ceilings, floors, corners, trim, roofs, windows, doors, shelving, cabinets, furniture, or other types of infrastructure, offering a streamlined and visually pleasing lighting solution for residential, commercial, and hospitality settings. By combining functionality and elegance, the trim device revolutionizes the presentation of LED strip lights, eliminating the need for complex architectural modifications and saving time, money, and effort in installation.

### SUMMARY OF THE INVENTION

The disclosed invention, known as the Lighting Trim Device, introduces an innovative all-in-one continuous longitudinal trim or moulding solution designed to conceal the direct glare emitted by LED strip lights, and offers numerous other benefits and features, distinguishing it vastly from other known devices and solutions. This emulates the functions of high-end architectural features such as bulkheads, covings, valances, accents, and insets. Serving as an accessory, the trim device complements and accentuates the installation of LED strip lights. Its specific design effectively houses and conceals the LED light strip while projecting their light onto adjacent and opposing surfaces, resulting in a visually appealing and evenly dispersed ambient glow. The trim device's stylish profile adds a touch of elegance to any space, whether the lights are on or off.

With its all-inclusive comprehensive design, no additional materials are required for installation. Its one-piece construction eliminates the need for assembly of multiple components, simplifying installation and setup, all while still allowing for custom-fitted applications. Requiring only a few basic tools for measuring and cutting, such as a tape measure and scissors or a knife. Cuts may be necessary for corners or endings in custom-fitted installs, but do not require additional connectors such as end caps or corner pieces, as the trim device design allows the fitting and joining of cut pieces together neatly and precisely.

The trim encompasses various embodiments, including L, V, U, C, triangle, square, rectangular, or similar cross-sectional shapes, each tailored to accommodate LED strip lights. Its unique design includes one open side or a translucent/opaque side that allows the light to escape in the direction away from the line of sight. The trim design can accommodate LED strip/rope/tape lights of any size.

Made of a continuous, flexible, and elastic rubber, silicone, or foam material the trim bends and curves, conforming to any desired shape or pattern during installation. Its compact design enables it to be rolled or bundled into a space-saving reel for packaging, storing, and delivery.

The trim device incorporates a built-in adhesive that securely mounts onto almost any surface, eliminating the need for additional fasteners or couplers. The installation process is quick and straightforward; simply peel and stick the trim device in the desired location, with the side including the adhesive onto the surface, pressing firmly to ensure a reliable bond. Once installed, the LED strip lights can be easily inserted through the open slot running along the entire length of the trim device without requiring a direct connection to the LED strips, eliminating the need to complete any electrical work.

In addition to its functional lighting effects benefits, when the LED lights within the Lighting Trim Device are turned off, it serves as a sleek and stylish visually pleasing moulding and a nice finishing touch to any space. Whether used in residential, commercial, or hospitality settings, the Lighting Trim Device enhances the overall aesthetics and ambiance.

### BRIEF DESCRIPTION OF THE DRAWINGS

The invention is further described in conjunction with the accompanying drawings, wherein: The reference characters (1, 2, 3, 4, 5, 6, 7, and 8) used in the drawings correspond to the same specific features of the trim device for all figures and embodiments of the invention as summarized: (1) Exterior shell. (2) Adhesive strip. (3) Rear side of the trim device. (4) Interior hollow core, (5) Platform for LED strip light, (6) LED strip light display. (7) Open slot for LED strip, and (8) Additional translucent/opaque side. Further details on these reference characters are provided in the detailed description section.

Drawing 1 of 3 includes 3 figures, which are two-dimensional cross-sectional illustrations showcasing different variations and embodiments of the trim device design. The figures display the L, V, U, C, triangle, and square, and rectangular shapes of the trim device and highlight seven key details.

Drawing 2 of 3 includes 1 figure, which is a two-dimensional cross-sectional illustration presenting a mixed embodiment of the trim device design as presented in Drawing 1 with an additional translucent/opaque side replacing the open side. This figure demonstrates the functionality of the trim device and features eight key details.

Drawing 3 of 3 includes 5 figures, providing different three-dimensional angle views of the same cross-sectional design from Drawing 2 of 3. These figures demonstrate the housing and concealment of the LED strips and share the same eight key details.

### DETAILED DESCRIPTION

In the following detailed description, specific embodiments of the present invention are described to provide a thorough understanding of the disclosure. However, it will be apparent to one skilled in the art that the disclosed embodiments may be practiced without these specific details. Well-known structures and functions have not been shown or described in detail to avoid unnecessarily obscuring the embodiments of the invention.

The Lighting Trim Device, as disclosed herein, is a revolutionary solution designed to house and conceal LED strip lights while enhancing their visual impact and diffusing glare. The trim device is formed from a flexible rubber, silicone, foam, or similar material, which allows it to be easily manipulated and installed in various settings.

In the illustrations provided in the drawings section, reference characters 1, 2, 3, 4, 5, 6, 7, and 8 are used to denote specific features of the trim device design. These reference characters are listed below as “detail” followed by the corresponding number. The details provided in the drawings align with the descriptions outlined.

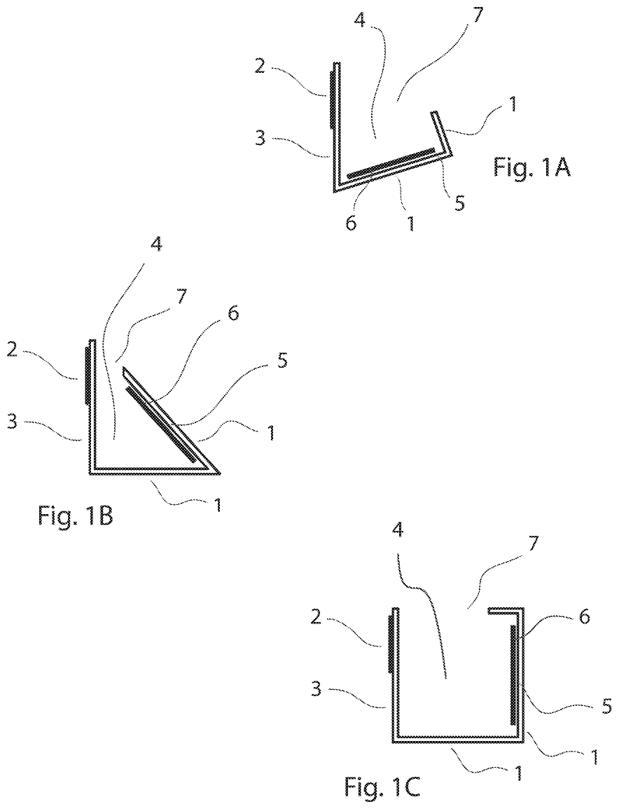

Drawing 1 of 3 includes 3 figures, which are cross sections of different variations of the trim design (FIGS. 1A, 1B, and 1C). Each figure represents a two-dimensional illustration showing the variances of the L, V, U, C, triangle, square, rectangular shapes within the trim device. These figures are referenced by the following detail numbers.

Detail 1 (FIGS. 1A, 1B, and 1C): Refers to the outside/exterior sides of the trim device that will be most visible once installed. Although the cross sections of the trim device differ in shape, they all share the same detail of being the exterior shell that conceals the LED strip on the inside.

Detail 2 (FIGS. 1A, 1B, and 1C): Refers to the adhesive strip located on the rear side of the exterior of the trim device. This adhesive strip is built into the trim device and comes with a protective film that can be peeled off before mounting the trim device to almost any hard surface.

Detail 3 (FIGS. 1A, 1B, and 1C): Refers to one of the exterior sides of the trim device, which can be considered the rear side of the trim device. This side gets placed on the hard surface and is also the same side where the adhesive strip is located.

Detail 4 (FIGS. 1A, 1B, and 1C): Refers to the inside/interior shape of the trim device for all three figures, it forms the hollow core of the trim device, housing and concealing the LED strip light. This hollow core of the trim device is not generally exposed to the user once installed and serves to house and conceal the LED strip light.

Detail 5 (FIGS. 1A, 1B, and 1C): Refers to one of the interior sides of the hollow core of the trim device. This side provides a platform on which the LED strip light is placed and rests.

Detail 6 (FIGS. 1A, 1B, and 1C): Refers to the LED strip light shown in these drawings for demonstration purposes only. It showcases the utility of the lighting trim device, although the LED strip light is not a direct accompanying part of the device invention.

Detail 7 (FIGS. 1A, 1B, and 1C): Refers to the open slot that allows the LED strip to be inserted through and allows the light to escape from the inside of the trim device to reflect onto adjacent and opposing surfaces. This side of the trim is installed facing away from the line of sight, preferably facing a near by opposing surface for optimal glow effect.

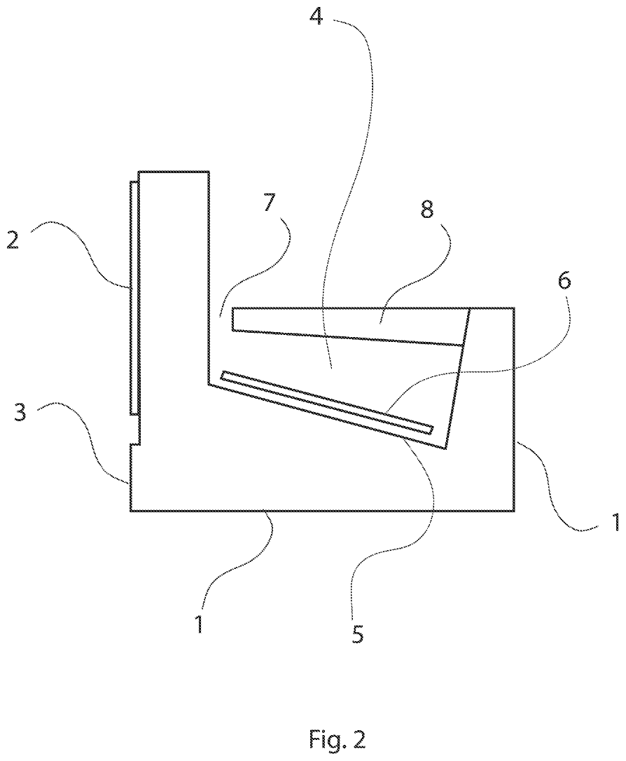

Drawing 2 of 3 includes 1 figure (FIG. 2), which represents a cross section of a different variation of the trim device design. This figure is a two-dimensional illustration showing a mixed embodiment of a U, C, square or rectangular-shaped cross section. The variation in this design compared to the previous figures is as follows:

Detail 1 (FIG. 2): Refers to the outside/exterior sides of the trim device that will be most visible once installed.

Detail 2 (FIG. 2): Refers to the adhesive strip located on the rear side of the exterior of the trim device. This adhesive strip is built into the trim device and comes with a protective film that can be peeled off before mounting the trim device to almost any surface.

Detail 3 (FIG. 2): Refers to one of the exterior sides of the trim device, which can be considered the rear side of the trim device. This side gets placed on the surface and is also the same side where the adhesive strip is located.

Detail 4 (FIG. 2): Refers to the inside/interior shape of the trim device, it forms the hollow core of the trim device, housing and concealing the LED strip light.

Detail 5 (FIG. 2): Refers to one of the interior sides of the hollow core of the trim device. This side serves as the platform on which the LED strip light is placed and rests.

Detail 6 (FIG. 2): Refers to the LED strip light shown in this drawing for demonstration purposes only. It showcases the utility of the lighting trim device, although the LED strip light is not a direct accompanying part of the device invention.

Detail 7 (FIG. 2): Refers to the open slot that allows the LED strip to be inserted or removed through, serving as a seam running along the entire length of the trim. The additional opaque/translucent side as described in detail 8, may reach and make full contact with the other end of the trim to form a closing, without being fully fused together to form a permanent enclosure. The flexibility of the trim device's material allows to be pried open for a wider opening when pressure is applied, and it regains its default shape once the pressure is released.

Detail 8 (FIG. 2): Refers to the additional side addition to the trim device design. This side is made of the same flexible material as the rest of the trim device but has a translucent/opaque appearance. It allows to dilute the LED dots while the light escapes from the inside of the trim device before reflecting onto adjacent and opposing surfaces, to further enhancing the overall ambient lighting effect. This side of the trim is installed facing away from the line of sight, preferably facing a near by opposing surface for optimal glow effect.

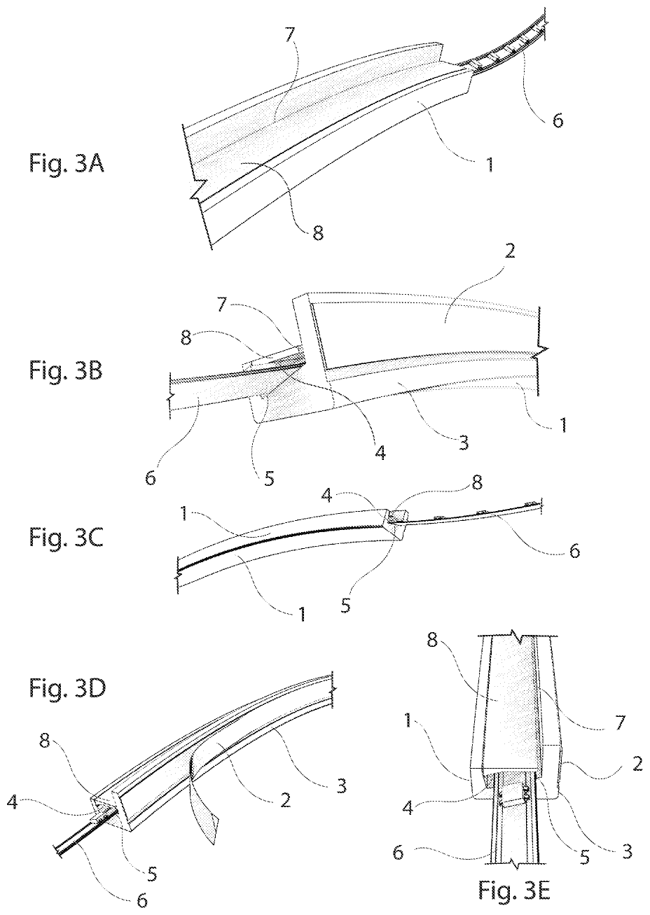

Drawing 3 of 3 includes 5 figures (FIGS. 3A, 3B, 3C, 3D, and 3E). These figures represent different three-dimensional angle views of the same cross-sectional design from Drawing 2. They demonstrate the housing and concealment of the LED strip lights. The details describing all eight characters in these figures are the same as those described in Drawing 2, corresponding to the respective detail numbers.

By incorporating these detailed drawings and descriptions, the Lighting Trim Device offers a comprehensive solution for concealing and enhancing the appearance of LED strip lights. The combination of its innovative design, flexible material, and easy installation process make it a versatile and aesthetically pleasing accessory for various indoor and outdoor lighting installations.

1. A lighting trim device, a longitudinal moulding as an accessory item for housing and concealing LED strip lights, comprising:
An elastic flexible material molded into an L, V, U, C, triangle, square, rectangular or a similar cross-sectional shape;
An open side or translucent/opaque side and a hollow inner section along the length of the trim device, designed to house and conceal the LED strip lights while allowing light to escape.
An outer side for attaching to surfaces.

2. The lighting trim device of claim 1, wherein the elastic material is rubber, silicone, foam, or other material which can be bent and flexed to a high degree to be shaped and molded.

3. The lighting trim device of claim 1 or 2, comprising an integrated adhesive layer applied to the outer side of the trim device for securing the trim device to any attachment surfaces, including a protective plastic film covering the built-in adhesive, for easy peel, apply, and press installation.

4. The lighting trim device of any preceding claim, wherein the trim device is easily customizable for specific custom fit installations, can be cut with regular scissors or knife, and joined together for custom fit installation requirements without need for specific connectors such as corners or end caps.

5. The lighting trim device of any preceding claim, wherein the trim device is rollable or bundlable into a compact form for efficient packaging, storage, and transportation.

6. The lighting trim device of any preceding claim, wherein the specific design of the trim device provides a diffusion effect by allowing position installation of the trim to project the source of light emitted by the LED strip placed inside away from the direct line of sight, and to reflect onto adjacent and opposing surfaces resulting in a consistent and evenly dispersed ambient glow.

7. The lighting trim device of any preceding claim, wherein the trim device is stylish with various textures and colors making it suitable for various indoor and outdoor lighting installations, architectural accents, and decorative lighting arrangements on walls, ceilings, floors, corners, trims or mouldings, roofs, siding, windows or doors, shelving, cabinets, furniture, or other type of hard surface of any infrastructure.

8. The lighting trim device of any preceding claim, wherein the trim device is capable of housing and concealing compatible LED strip lights of various sizes, types, and configurations.

9. The lighting trim device of any preceding claim, wherein the LED strip light is easily inserted into and removed from the lighting trim device through the open slot along the entire length of the lighting trim while fully installed and attached to surface, eliminating the need for LED strip connections or any electrical assembly.

10. The lighting trim device of any preceding claim, wherein the trim device is a continuous intact all-in-one combined singular unit, not of multiple pieces requiring assembly.
